(19) United States
(12) Patent Application Publication
(10) Pub. No.: US 2009/0292783 A1
(43) Pub. Date: Nov. 26, 2009

(54) System, apparatus and method for event management

(76) Inventor: Casey Burke, Glen Allen, VA (US)

Correspondence Address: SQUIRE, SANDERS & DEMPSEY L.L.P., 8000 TOWERS CRESCENT DRIVE, 14TH FLOOR, VIENNA, VA, 22182-6212, US

(21) Appl. No.: 12/453,391

(22) Filed: May 8, 2009

Related U.S. Application Data
(60) Provisional application No. 61/128,335, filed on May 22, 2008.

(51) Int. Cl. G06F 3/01; G06F 15/16

(52) U.S. Cl. 709/206; 715/751

(57) ABSTRACT

A system, apparatus and method may perform event management by creating an electronic event based on received event data corresponding to an event, where the event data includes information pertaining to the event and invitees to be invited to the event, storing one or more responses received from one or more of the invitees, where each respective response includes an indication of whether the respective invitee will attend the event, storing post-event content pertaining to the event and associating the post-event content with the electronic event, where the post-event content is received from an invitee or a creator of the electronic event, and transmitting the post-event content to a requesting invitee or the creator of the electronic event at the request of the requesting invitee or the creator of the electronic event.

### CROSS REFERENCE TO RELATED APPLICATIONS

This application claims priority under 35 U.S.C. §119(e)(1) of U.S. Provisional Patent Application No. 61/128,335, filed May 22, 2008. The subject matter of this earlier filed application is hereby incorporated by reference in its entirety.

### BACKGROUND

1. Field

The present invention relates generally to event management. More specifically, the present invention relates to apparatuses, systems and methods for performing end-to-end event management, including post-event management.

2. Description of the Related Art

Services exist that allow planners of events to create and/or customize a website pertaining to an event, such as a wedding. Potential attendees may login to the website and view certain details pertaining to the event, such as the location, date and time of the event. However, while existing services allow guests to login and view certain details associated with an event, the website ceases to have value after the event has occurred since the features thereof are no longer useful to most attendees. Accordingly, it may be advantageous to such service providers to include post-event management features that extend the useful life cycle of digital content related to events.

### SUMMARY

Certain embodiments of the present invention may provide solutions to the problems and needs in the art that have not yet been fully solved by currently available visualization technologies. For example, certain embodiments of the present invention may provide, for instance, apparatuses, systems and methods for performing end-to-end event management, including post-event management.

In an embodiment of the present invention, a method may include creating, by a computing unit, an electronic event based on received event data corresponding to an event. The event data may include information pertaining to the event and invitees to be invited to the event. The method may also include storing, by the computing unit, one or more responses received from one or more of the invitees. Each respective response may include an indication of whether the respective invitee will attend the event. The method may further include storing, by the computing unit, post-event content pertaining to the event and associating the post-event content with the electronic event. The post-event content may be received from an invitee or a creator of the electronic event. Additionally, the method may include transmitting, by the computing unit, the post-event content to a requesting invitee or the creator of the electronic event at the request of the requesting invitee or the creator of the electronic event.

In some embodiments, the method may further include transmitting, by the computing unit, an e-mail or cellular phone text message to one or more of the invitees indicating that information pertaining to the event has changed or new images, videos or text related to the event are available. In certain embodiments, the method may include associating the electronic event, by the computing unit, with one or more previous electronic events such that digital content associated with the one or more previous electronic events is accessible by one or more invitees of the event. In some embodiments, the method may include transmitting, by the computing unit, an automatically generated personalized message specific to the respective invitee in response to the respective invitee responding to an invitation. The message may be different based on whether the invitee chooses to attend or not attend the event.

In certain embodiments, the method may include providing to an invitee, by the computing unit, information pertaining to points of interest located within a predetermined proximity to a location of the event. In some embodiments, the method may further include transmitting an electronic invitation to the invitees including custom queries associated with the electronic invitation. The custom queries may be generated by the creator of the electronic event.

In another embodiment of the present invention, an apparatus may include an event creation unit configured to create an electronic event based on received event data corresponding to an event. The event data may include information pertaining to the event and invitees to be invited to the event. The apparatus may also include a storage unit configured to store one or more responses for the electronic event received from one or more of the invitees. Each respective response may include an indication of whether the respective invitee will attend the event. The storage unit may be configured to store post-event content pertaining to the event and to associate the post-event content with the electronic event. The post-event content may be received from an invitee or a creator of the electronic event. The apparatus may further include a transmitting unit configured to transmit the post-event content to a requesting invitee or the creator of the electronic event at the request of the requesting invitee or the creator of the electronic event.

In some embodiments, the transmitting unit may be further configured to transmit an e-mail or cellular phone text message to one or more of the invitees indicating that information pertaining to the event has changed or new images, videos or text related to the event are available. In certain embodiments, the apparatus may further include an associating unit configured to associate the electronic event with one or more previous electronic events such that digital content associated with the one or more previous electronic events is accessible by one or more invitees of the event. In some embodiments, the transmitting unit may be further configured to transmit an automatically generated personalized message specific to the respective invitee in response to the respective invitee responding to an invitation. The message may be different based on whether the invitee chooses to attend or not attend the event.

In some embodiments, the transmitting unit may be further configured to transmit information to an invitee pertaining to points of interest located within a predetermined proximity to a location of the event. In some embodiments, the transmitting unit may be further configured to transmit custom queries associated with an electronic invitation to the invitees. The custom queries may be generated by the creator of the electronic event.

### BRIEF DESCRIPTION OF THE DRAWINGS

In order that the embodiments of the invention will be readily understood, a more particular description of the invention briefly described above will be rendered by reference to specific embodiments that are illustrated in the appended drawings. While it should be understood that these drawings illustrate only typical embodiments of the invention and are not therefore to be considered to be limiting of its scope, the invention will be described and explained with additional specificity and detail through the use of the accompanying drawings, in which:

FIG. 1 is an architectural diagram illustrating a system for performing end-to-end event management, according to an embodiment of the present invention.

FIG. 2 is a block diagram illustrating a server for providing end-to-end event management in accordance with an embodiment of the present invention.

FIG. 3 is a flow chart diagram illustrating a method for providing end-to-end event management in accordance with an embodiment of the present invention.

FIG. 4 is a screenshot illustrating a web page for the selection of an event type and theme in accordance with an embodiment of the present invention.

FIG. 5 is a screenshot illustrating a web page for setting event details and guest information in accordance with an embodiment of the present invention.

FIG. 6 is a screenshot illustrating a web page for previewing and publishing an electronic event in accordance with an embodiment of the present invention.

FIG. 7 is a screenshot illustrating a web page for entering host information in accordance with an embodiment of the present invention.

FIG. 8 is a screenshot 800 illustrating a web page for managing events in accordance with an embodiment of the present invention.

FIG. 9 is a screenshot 900 illustrating a web page for viewing event posts from invitees in accordance with an embodiment of the present invention.

FIG. 10 is a screenshot 1000 illustrating a web page for an address book in accordance with an embodiment of the present invention.

FIG. 11 is a screenshot 1100 illustrating a web page for managing host account information in accordance with an embodiment of the present invention.

FIG. 12 is a screenshot 1200 illustrating a web page for managing partners and affiliates in accordance with an embodiment of the present invention.

### DETAILED DESCRIPTION

It will be readily understood that the components of various embodiments of the present invention, as generally described and illustrated in the figures herein, may be arranged and designed in a wide variety of different configurations. Thus, the following more detailed description of the embodiments of an apparatus, system, and method of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

In addition, while the term “server” has been used in the description of some embodiments of the present invention, the invention may be applied to many types of network devices. For purposes of this invention, the term “server” includes rack computing systems, personal computers, laptops, cell phones, personal digital assistants, tablet computing devices, mainframes, any networked devices that perform computing operations, and any equivalents thereof.

Further, the term “event” may refer to any planned physical event. For instance, an “event” may be a wedding, a graduation, a birthday, a baby shower, a wedding shower, or any other celebration. An “event” may also be a corporate event (such as a company picnic, golf outing, or any other event initiated or sponsored by a company), an event for charity, a sporting event and or a community event. An “event” may further be a non-physical event such as acceptance to a university, acceptance of a job application or acceptance of a loan application. The aforementioned types of events are offered by way of example only and are not intended to be limiting as to the types of physical and non-physical (e.g., virtual) events that fall within the scope of the present application.

It may be beneficial to provide a new electronic way to RSVP to an event and to perform end-to-end event management. Events that traditionally would have physical correspondence, invitations and/or acceptance letters may be more conveniently provided in an electronic format, such as a website or other computer program application. In this manner, invitees may RSVP without the hassle of lost RSVP cards and without the additional cost of postage to the event planner for a mailed RSVP card. In some embodiments, the host may send physical RSVP cards with a username and password for the guest to electronically RSVP to the event, an electronic invitation delivered via e-mail, text or some other electronic medium, or both.

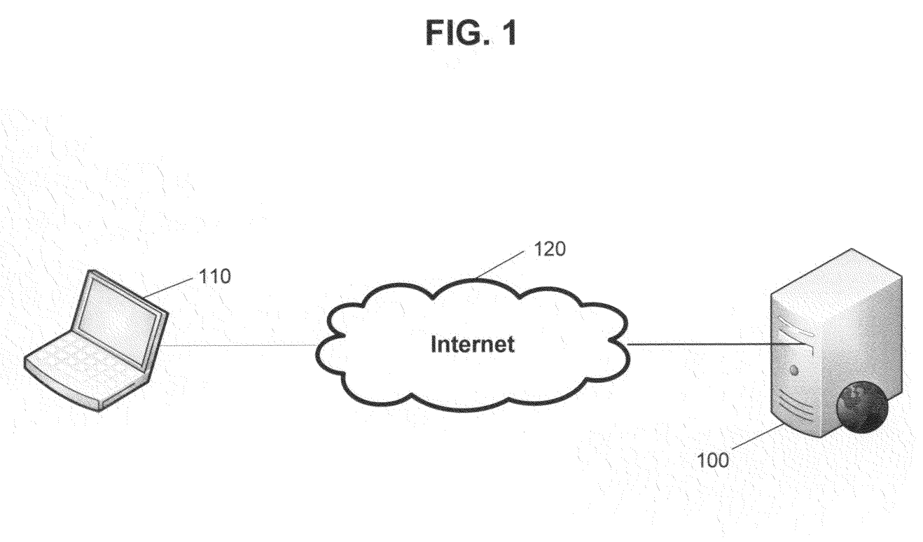

FIG. 1 is an architectural diagram illustrating a system for performing end-to-end event management, according to an embodiment of the present invention. The system includes a server 100 and a personal computer 110 that are connected to the Internet 120. While a personal computer 110 is depicted, in some embodiments, the server 100 may communicate with a cell phone, PDA, or any other personal computing device. In the depicted embodiment, the server 100 may host a website related to an electronic event. To access the website, a user of the personal computer 110 may use a web address that was provided to the user via an e-mail or a physical invitation card, for instance. The user may then access the website hosted by the server 100 via the personal computer 110 and utilize the functionality of the website.

The website may include customized pages that allow the user to view personal photos, a custom page layout and event details that the event creator has provided. The user may choose to attend or send regrets and have access to an event menu, registries, accommodations and have access to a place to attach a personal written, audio or video response. The event planner may decide to request certain customizable information from the user based on what information the event planner wishes to receive. For instance, for an event planner may wish to know the number of additional guests an invitee will be bringing and the names and contact information of the additional guests. The website may also allow the user to make monetary gifts via a gift service, such as that provided by VISA Corp.

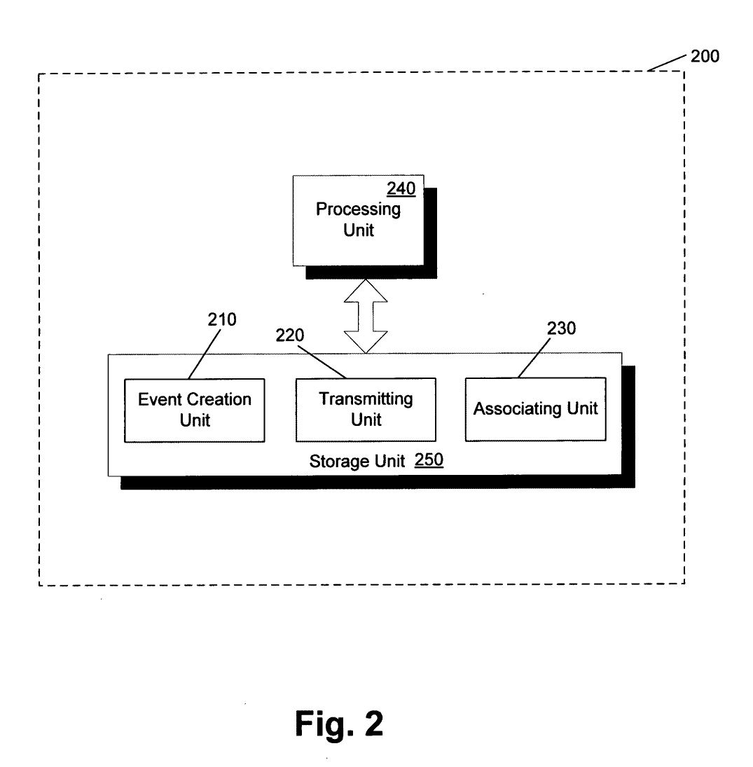

FIG. 2 is a block diagram illustrating a server 200 for providing end-to-end event management in accordance with an embodiment of the present invention. The server 200 includes an event creation unit 210, a transmitting unit 220, an associating unit 230, a processing unit 240 and a storage unit 250. In some embodiments, the server 200 may be the server 100 of FIG. 1.

The event creation unit 210 may be configured to create an electronic event based on received event data corresponding to an event. The event data may include information pertaining to the event and invitees to be invited to the event. The transmitting unit 220 may be configured to transmit an electronic invitation to view the electronic event to the invitees. The storage unit 250 may be configured to store one or more responses for the electronic event received from one or more of the invitees. Each respective response may include an indication of whether the respective invitee will attend the event. The storage unit 250 may also be configured to store post-event content pertaining to the event and to associate the post-event content with the electronic event. The post-event content may be received from an invitee or a creator of the electronic event. The transmitting unit 220 may be configured to transmit the post-event content to a requesting invitee or the creator of the electronic event at the request of the requesting invitee or the creator of the electronic event. In some embodiments, either in addition to or in lieu of receiving an electronic invitation, invitees may receive a physical invitation and respond to events by entering a username and password from the physical invitation.

The transmitting unit 220 may be further configured to transmit an e-mail or cellular phone text message to one or more of the invitees indicating that information pertaining to the event has changed or new images, videos or text related to the event are available. The associating unit 230 may be configured to associate the electronic event with one or more previous electronic events such that digital content associated with the one or more previous electronic events is accessible by one or more invitees of the event. The transmitting unit 220 may be further configured to transmit an automatically generated personalized message specific to the respective invitee in response to the respective invitee responding to the invitation. The message may be different based on whether the invitee chooses to attend or not attend the event.

The transmitting unit 220 may be further configured to transmit information to an invitee pertaining to points of interest located within a predetermined proximity to a location of the event. The transmitting unit 220 may be further configured to transmit custom queries associated with the electronic invitation to the invitees. The custom queries may be generated by the creator of the electronic event.

It should be noted that many of the functional features described in this specification have been presented as units in order to more particularly emphasize their implementation independence. For example, a unit may be implemented as a hardware circuit comprising custom very large scale integration (VLSI) circuits or gate arrays, off-the-shelf semiconductors such as logic chips, transistors, or other discrete components. A unit may also be implemented in programmable hardware devices such as field programmable gate arrays, programmable array logic, programmable logic devices or the like.

Units may also be at least partially implemented in software for execution by various types of processors. An identified unit of executable code may, for instance, comprise one or more physical or logical blocks of computer instructions which may, for instance, be organized as an object, procedure or function. Nevertheless, the executables of an identified unit need not be physically located together, but may comprise disparate instructions stored in different locations which, when joined logically together, comprise the unit and achieve the stated purpose for the unit. Units may be stored on a computer-readable medium, which may be, for instance, a hard disk drive, a flash device, random access memory (RAM), a tape drive, an optical drive, a CD-ROM or DVD-ROM, or any other such medium used to store data.

Indeed, a unit of executable code could be a single instruction, or many instructions, and may even be distributed over several different code segments, among different programs, and across several memory devices. Similarly, operational data may be identified and illustrated herein within units, and may be embodied in any suitable form and organized within any suitable type of data structure. The operational data may be collected as a single data set, or may be distributed over different locations including over different storage devices, and may exist, at least partially, merely as electronic signals on a system or network.

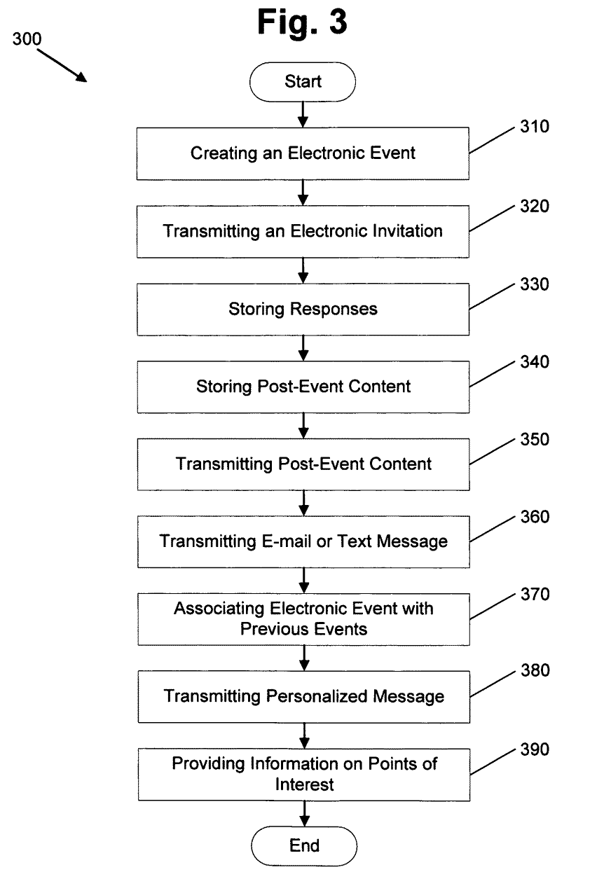

FIG. 3 is a flow chart diagram illustrating a method 300 for providing end-to-end event management in accordance with an embodiment of the present invention. The method 300 includes creating an electronic event 310, transmitting an electronic invitation 320, storing responses 330, storing post-event content 340, transmitting post-event content 350, transmitting an e-mail or text message 360, associating an electronic event with previous events 370, transmitting a personalized message 380 and providing information on points of interest 390. In some embodiments, the method 300 may be performed by the servers 100 or 200 of FIGS. 1 or 2. The method may also be performed by a computing unit, which may be any computing device, such as a processor, a computer, a PDA, a cell phone or any other device that performs computing operations. In some embodiments, either in addition to or in lieu of receiving an electronic invitation, invitees may receive a physical invitation and respond to events by entering a username and password from the physical invitation.

The creating of the electronic event 310 may include creating the electronic event based on received event data corresponding to an event. The event data may include information pertaining to the event and invitees to be invited to the event. The transmitting of the electronic invitation 320 may include transmitting the electronic invitation to view the electronic event to the invitees. The storing of the responses 330 may include storing one or more responses to the electronic invitation received from one or more of the invitees. Each respective response may include an indication of whether the respective invitee will attend the event. The storing of the post-event content 340 may include storing the post-event content pertaining to the event and associating the post-event content with the electronic event. The post-event content may be received from an invitee or a creator of the electronic event. The transmitting of the post-event content 350 may include transmitting the post-event content to a requesting invitee or the creator of the electronic event at the request of the requesting invitee or the creator of the electronic event.

The transmitting of the e-mail or text message 360 may include transmitting the e-mail or cellular phone text message to one or more of the invitees indicating that information pertaining to the event has changed or new images, videos or text related to the event are available. The associating of the electronic event with previous events 370 may include associating the electronic event with one or more previous electronic events such that digital content associated with the one or more previous electronic events is accessible by one or more invitees of the event. The transmitting of the personalized message 380 may include transmitting an automatically generated personalized message specific to the respective invitee in response to the respective invitee responding to the invitation. The message may be different based on whether the invitee chooses to attend or not attend the event.

The providing of information on points of interest 390 may include providing information to an invitee pertaining to points of interest located within a predetermined proximity to a location of the event. The transmitting of the electronic invitation to the invitees 320 may further include transmitting custom queries associated with the electronic invitation. The custom queries may be generated by the creator of the electronic event.

A website according to some embodiments of the present invention may have a dual purpose. First, the site may make responding to events easier and more entertaining for guests (invitees) as well as providing an event information hub that is available to guests at any time. Second, the site may provide a way for those planning events (hosts) to create content that is customized to their celebration and allows the hosts to easily manage their guests. In some embodiments, a phone number may be provided to assist those who are not Internet-savvy.

Another advantage of some embodiments of the present invention is that the events do not necessarily need to be physical. For instance, a university may act as the “host” and choose to provide acceptance letters to applicants via a web RSVP portal. Students would be able to respond to offer letters through this portal. The web pages created by the university may include custom info and pictures and the university may use the electronic responses from students to gather information about students provide students with links that they might find useful. The university may further put students who have accepted offers in touch with other students that have accepted offers and alumni that are located within a certain proximity of the accepting students. The university may further inform students of events that will be taking place for incoming students in their area.

As a Guest

Guests to the site may have a custom username and password provided by the host that is printed on a physical invitation or sent via e-mail. Once the guest visits the website, the guest may be required to enter your username and password. The site may up to the custom RSVP page that has been designed by the host for the guests. Here, guests may see an event title, a review of event details, and a RSVP box where the guest is prompted to enter his/her name and click on a box to Attend or Send Regrets. Guests may also see a personalized note from the host, personal photos dealing with the event such as engagement or senior pictures, personal video footage, and/or a choice background layout. Guests may also be provided with helpful links for the event. When responding, Guests may further send a personalized message to the host. In the process of providing information on the RSVP page, the guest may enter information such as the number of guests and menu choices for each guest.

As a Host

In some embodiments, hosts will create a username and a password when they first visit the site. This username and password may enable the host to access site administration for any electronic event that the host creates, as well as enabling the host to manage responses for these events. The event creation and management functionality with respect to an embodiment of the present invention is described below.

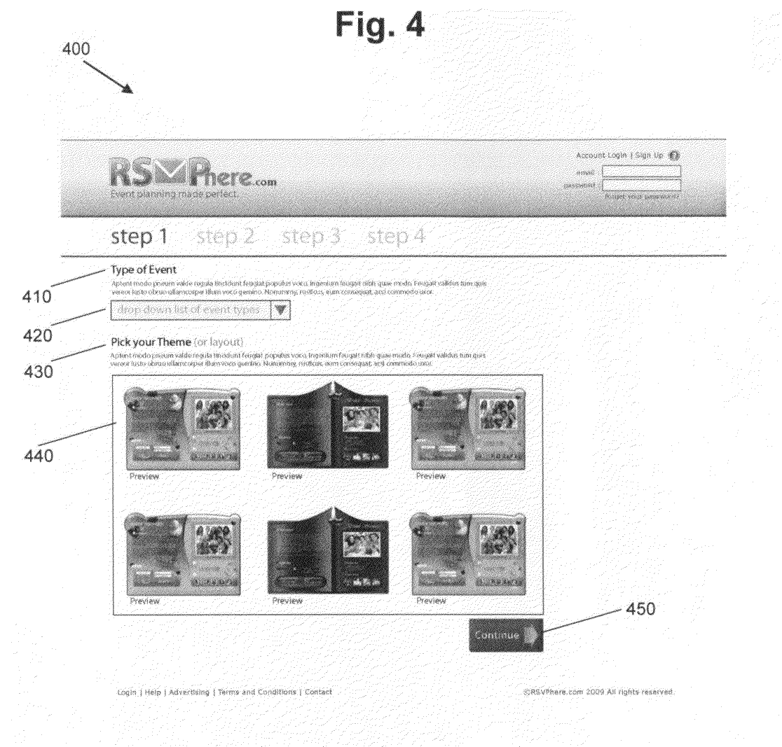

FIG. 4 is a screenshot 400 illustrating a web page for the selection of an event type and theme in accordance with an embodiment of the present invention. As can be seen, the host may select the type of the event 410 from the depicted dropdown box 420. It is noted that the event type selection is not limited to a dropdown box and may be performed by any HTML web component, text input, a link, or any other suitable mechanism. The host may then pick a theme 430 by selecting a template 440 from an assortment of provided templates. The host may then click the continue button 450 to continue to the next step in the event creation logic.

The RSVPhere.com logo and slogan “event planning made perfect” illustrated in FIGS. 4-12 are trademarks of RSVPhere.com and are not dedicated to the public by this application. A portion of the disclosure of this patent document, illustrated in FIGS. 4-12, also contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

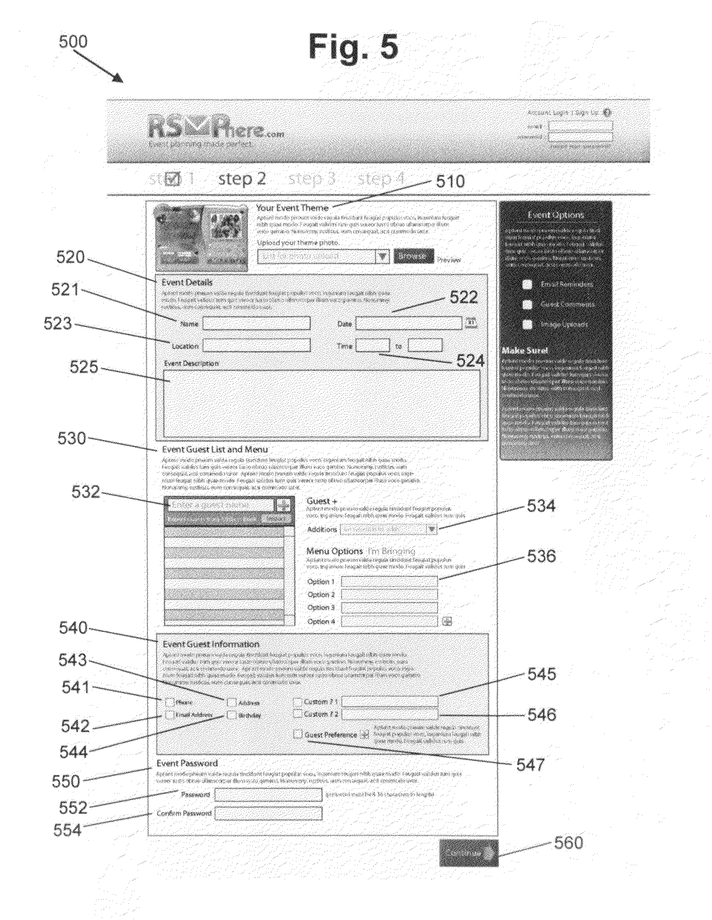

FIG. 5 is a screenshot 500 illustrating a web page for setting event details and guest information in accordance with an embodiment of the present invention. As can be seen, the event theme 510 may be displayed on the page—in this case, a theme for a baby shower. The host may set event details 520 pertaining to the event. In FIG. 5, these details include the event name 521, the date 522, the location 523, the time 524 and a description of the event 525. The depicted screenshot also includes an event guest list and menu 530 including entry/selection of a guest name 532, the number of additional guests the selected guest may bring 534 and menu options 536 that the guest is either requested to bring in the case an event is not catered or would like to be served in the case that the event is catered.

The host may also set the event guest information 540 that the host would like to receive in an RSVP from each guest. In the depicted screenshot 500, the information includes a phone number 541, an e-mail address 542, an address 543, birthday 544, two custom fields 545 and 546 and a guest preference 547. The host may also establish an event password 550 for the guest. The host enters the password 552 and confirms the password 554. The host may then click the continue button 560 to continue to the next step in the event creation logic.

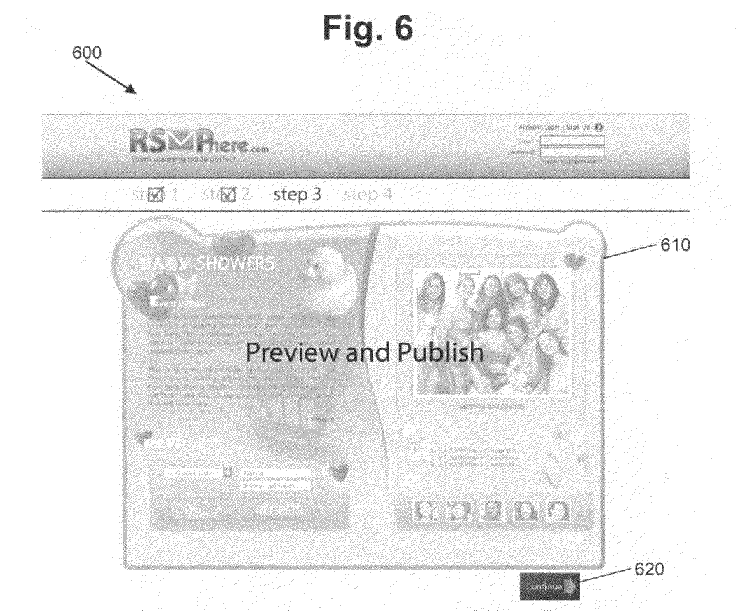

FIG. 6 is a screenshot 600 illustrating a web page for previewing and publishing an electronic event in accordance with an embodiment of the present invention. The screenshot 600 depicts a page having a preview and publish section 610 that allows a host to view a sample of what an invitation will look like. The host may then click the continue button 620 to continue to the next step in the event creation logic.

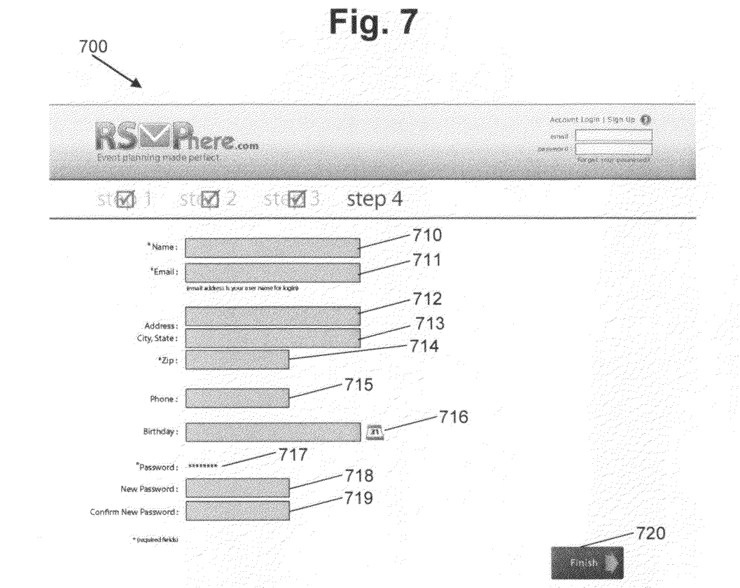

FIG. 7 is a screenshot 700 illustrating a web page for entering host information in accordance with an embodiment of the present invention. As can be seen, the fields marked with an asterisk (*) may be required fields. The fields in the depicted screenshot include name 710, e-mail 711, address 712, city and state 713, Zip code 714, telephone number 715, birthday and calendar date selection tool 716, new password 718 and a confirmation of the new password 719. The old password is shown 717 with the actual password replaced by asterisks. The host may complete the event creation by clicking the finish button 720. In some embodiments, during the event creation process, it may be possible to import information from previous events into the current event that the host is creating.

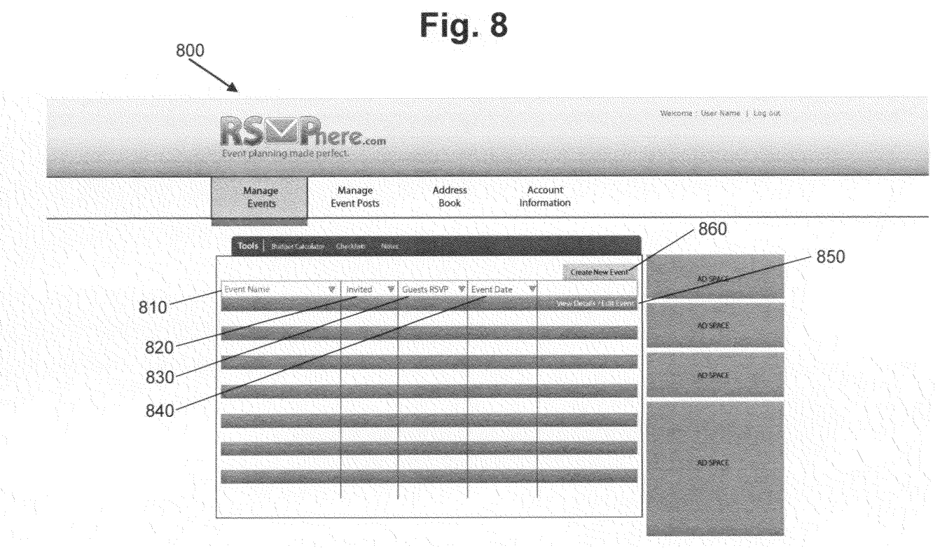

In some embodiments, it is possible for the host to manage various information. FIG. 8 is a screenshot 800 illustrating a web page for managing events in accordance with an embodiment of the present invention. The displayed fields may include the event name 810, the number of invited guests 820, the number of guests that chose to RSVP 830 and the event date 840. In some embodiments, the host may also choose to view further event details and/or edit the event 850. The host may choose to change event details and provide additional information pertaining to the event, upload photos to a photo/video gallery within the site, include helpful information such as hotels located near the event and the like. The host may also be able to create a new event 860.

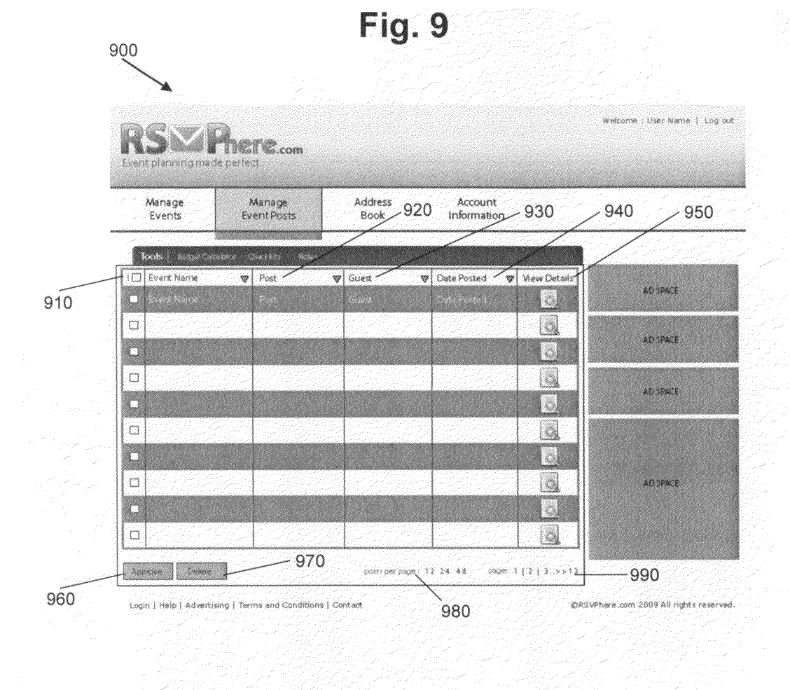

FIG. 9 is a screenshot 900 illustrating a web page for viewing event posts from invitees in accordance with an embodiment of the present invention. This section may function as an e-mail inbox that allows the host to maintain the privacy of his or her personal e-mail address and that offers a central location for RSVP mail. The site server may also forward guest posts to one or more other e-mail addresses designated by the host. E-mails associated with events may be automatically deleted after a set period of time and may be sorted by categories such as date, sender or event. In some embodiments, the host may select a post 910, view the title of the post 920, view the guest that made the post 930, see the date the post was made 940 and view further details associated with the post 950 (for instance, the text in the body of the post). The host may approve 960 or delete 970 one or more selected posts. The host may also be able to change the number of posts per page 980 or change the page of posts to be viewed 990.

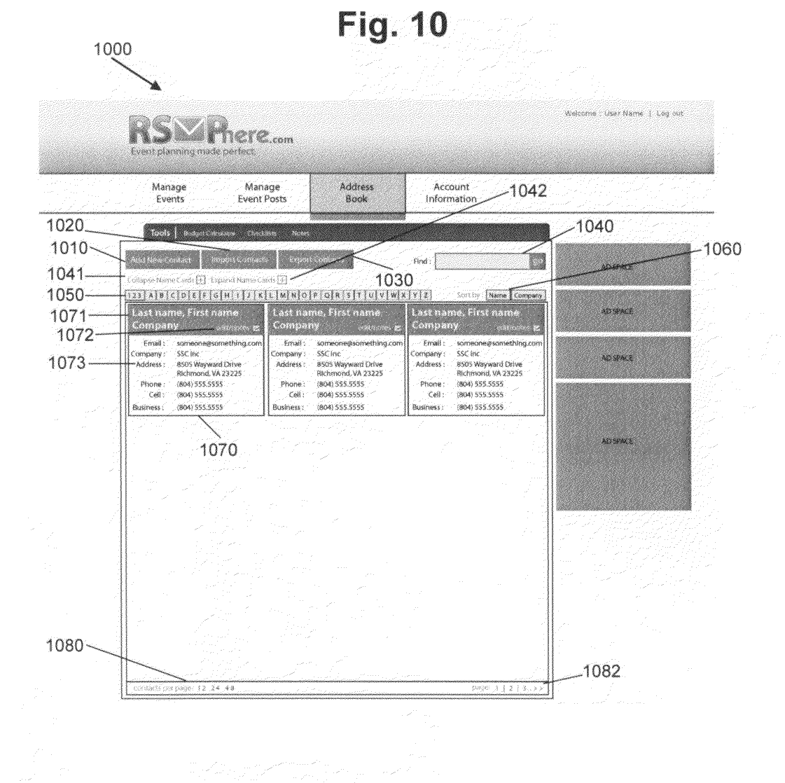

FIG. 10 is a screenshot 1000 illustrating a web page for an address book in accordance with an embodiment of the present invention. The Add New Contact button 1010 may allow the host to add new contacts to the address book. The Import Contacts button 1020 may allow the host to import addresses from other applications, such as Evite®, Excel® or Outlook®. The Export Contacts button 1030 may enable to host to export contacts to other applications. The address book may also be implemented with a fund function 1040 that enables the host to search the address book for various keywords, patterns and phrases.

In some embodiments, the address book may be implemented such that information may be added/removed at any time and saved. Some implementations may also allow a host to use an address book that was created for a previous event. Further, information such as category (i.e. friend, family, work associate, potential client, etc.) and contact information may be imported into the address book as the associated person provides the information in the context of the event.

The address book may show guest cards 1070 that may be expandable 1040 and collapsible 1042. Guest cards 1070 beginning with a certain number 1050 may be selected and displayed. The address book may also be sorted 1060 (for instance, by name, e-mail address, category, company, etc.) for ease of use and management. In some embodiments, the name cards may contain a header 1071 having the first and last name of a guest and an associated company. An edit/notes button 1072 on the card may enable the host to edit guest information and make various notes about the guest. The body 1073 of the guest card 1070 may contain information such as e-mail, company, address and phone numbers.

Similar to the page for viewing event posts depicted in FIG. 9, the host may be able to set the number of guest cards 1080 to appear per page and the page of results 1082 that the host desires to view. When setting up an event, the host may be prompted to add people from a pre-existing address book if such an address book already exists for the host. Further, the host may be prompted to create an address book during event creation if such an address book does not exist.

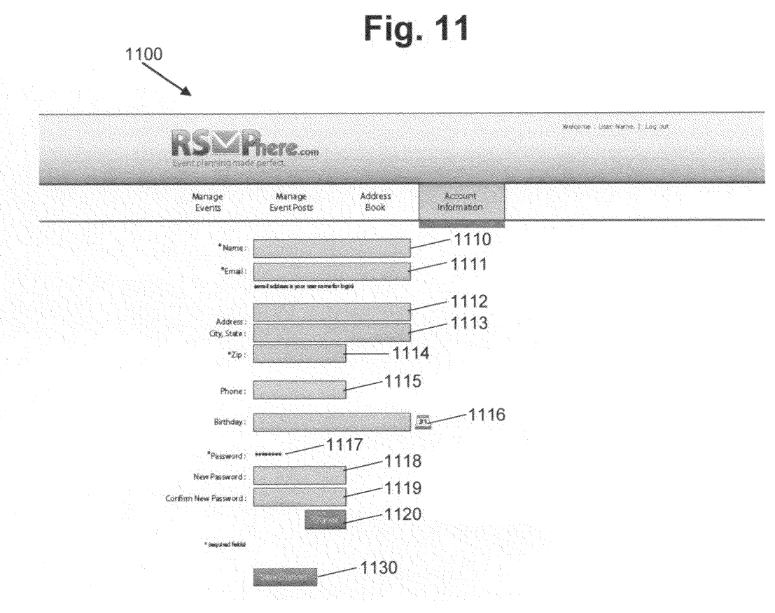

FIG. 11 is a screenshot 1100 illustrating a web page for managing host account information in accordance with an embodiment of the present invention. As can be seen, the fields marked with an asterisk (*) may be required fields. Similar to FIG. 7, fields in the depicted screenshot 1100 include name 1110, e-mail 1111, address 1112, city and state 1113, Zip code 1114, telephone number 1115, birthday and calendar date selection tool 1116, new password 1118 and a confirmation of the new password 1119. The old password is shown 1117 with the actual password replaced by asterisks. In some embodiments, the host may change the password using the Change button 1120. The host may save changes to the account information by clicking the Save Changes button 1030. In implementations where the host is charged a fee for use of the site, payment information may also be managed. An e-mail may be sent to the host notifying the host of any changes made to the account when such changes to account information are submitted.

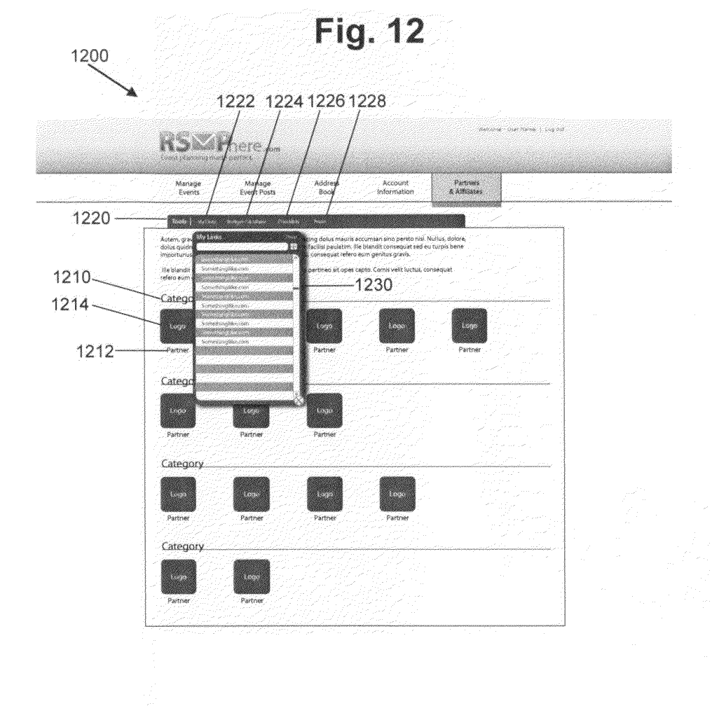

In some embodiments, the website may further include a page for managing partners and affiliates. FIG. 12 is a screenshot 1200 illustrating a web page for managing partners and affiliates in accordance with an embodiment of the present invention. The partners and affiliates page may include various categories 1210 and various partners 1212 organized by each category 1210. A logo 1214 that is associated with a given partner 1212 may also be displayed. In some embodiments, partners and affiliates may be established during event creation. As also seen in FIGS. 8-11, one or more pages for the host may also include a Tools section 1220 than includes various helpful tools for the host. For example, in the depicted screenshot 1200, a popup menu 1230 for managing helpful online links is shown. This may be selected by using the My Links link 1222 of the Tools section 1220. Under the popup menu 1230, the host may add, remove or modify links associated with various helpful sites. The tools section 1220 also includes a Budget Calculator 1224 for helping a host to plan an event budget and Checklists 1226 that allow the host to create a list of items that must be taken care of for the event and allow the host to track completion of these items. Additionally, the Tools section 1220 includes Notes functionality 1228 that enables the host to make notes about the event, attach images and files, and keep a journal. In some embodiments, other tools, such as a drink calculator, may be included.

One having ordinary skill in the art will readily understand that the invention as discussed above may be practiced with steps in a different order, and/or with hardware elements in configurations that are different than those that are disclosed. Therefore, although the invention has been described based upon these preferred embodiments, it would be apparent to, and readily appreciated by, those of ordinary skill in the art that certain modifications, variations, and alternative constructions would be apparent, while remaining within the spirit and scope of the invention. In order to determine the metes and bounds of the invention, therefore, reference should be made to the appended claims.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

We claim:

1. A method, comprising:
creating, by a computing unit, an electronic event based on received event data corresponding to an event, wherein the event data comprises information pertaining to the event and invitees to be invited to the event;
storing, by the computing unit, one or more responses received from one or more of the invitees, wherein each respective response comprises an indication of whether the respective invitee will attend the event;
storing, by the computing unit, post-event content pertaining to the event and associating the post-event content with the electronic event, wherein the post-event content is received from an invitee or a creator of the electronic event; and
transmitting, by the computing unit, the post-event content to a requesting invitee or the creator of the electronic event at the request of the requesting invitee or the creator of the electronic event.

2. The method of claim 1, further comprising:
transmitting, by the computing unit, an e-mail or cellular phone text message to one or more of the invitees indicating that information pertaining to the event has changed or new images, videos or text related to the event are available.

3. The method of claim 1, further comprising:
associating the electronic event, by the computing unit, with one or more previous electronic events such that digital content associated with the one or more previous electronic events is accessible by one or more invitees of the event.

4. The method of claim 1, further comprising:
transmitting, by the computing unit, an automatically generated personalized message specific to the respective invitee in response to the respective invitee responding to an invitation, wherein the message is different based on whether the invitee chooses to attend or not attend the event.

5. The method of claim 1, further comprising:
providing to an invitee, by the computing unit, information pertaining to points of interest located within a predetermined proximity to a location of the event.

6. The method of claim 1, wherein the method further comprises:
transmitting, by the computing unit, an electronic invitation to the invitees including custom queries associated with the electronic invitation, wherein the custom queries are generated by the creator of the electronic event.

7. An apparatus, comprising:
an event creation unit configured to create an electronic event based on received event data corresponding to an event, wherein the event data comprises information pertaining to the event and invitees to be invited to the event;
a storage unit configured to store one or more responses for the electronic event received from one or more of the invitees, wherein each respective response comprises an indication of whether the respective invitee will attend the event, the storage unit is configured to store post-event content pertaining to the event and to associate the post-event content with the electronic event, and the post-event content is received from an invitee or a creator of the electronic event; and
a transmitting unit configured to transmit the post-event content to a requesting invitee or the creator of the electronic event at the request of the requesting invitee or the creator of the electronic event.

8. The apparatus of claim 7, wherein the transmitting unit is further configured to transmit an e-mail or cellular phone text message to one or more of the invitees indicating that information pertaining to the event has changed or new images, videos or text related to the event are available.

9. The apparatus of claim 7, further comprising:
an associating unit configure to associate the electronic event with one or more previous electronic events such that digital content associated with the one or more previous electronic events is accessible by one or more invitees of the event.

10. The apparatus of claim 7, wherein the transmitting unit is further configured to transmit an automatically generated personalized message specific to the respective invitee in response to the respective invitee responding to an invitation, wherein the message is different based on whether the invitee chooses to attend or not attend the event.

11. The apparatus of claim 7, wherein the transmitting unit is further configured to transmit information to an invitee pertaining to points of interest located within a predetermined proximity to a location of the event.

12. The apparatus of claim 7, wherein the transmitting unit is further configured to transmit custom queries associated with an electronic invitation to the invitees, wherein the custom queries are generated by the creator of the electronic event.

13. A computer program embodied on a computer-readable storage medium, the program configured to control a processor to perform a process, the process comprising:
creating an electronic event based on received event data corresponding to an event, wherein the event data comprises information pertaining to the event and invitees to be invited to the event;
storing one or more responses received from one or more of the invitees, wherein each respective response comprises an indication of whether the respective invitee will attend the event;
storing post-event content pertaining to the event and associating the post-event content with the electronic event, wherein the post-event content is received from an invitee or a creator of the electronic event; and
transmitting the post-event content to a requesting invitee or the creator of the electronic event at the request of the requesting invitee or the creator of the electronic event.

14. The computer program of claim 13, the process further comprising:
transmitting an e-mail or cellular phone text message to one or more of the invitees indicating that information pertaining to the event has changed or new images, videos or text related to the event are available.

15. The computer program of claim 13, the process further comprising:
associating the electronic event with one or more previous electronic events such that digital content associated with the one or more previous electronic events is accessible by one or more invitees of the event.

16. The computer program of claim 13, the process further comprising:
transmitting an automatically generated personalized message specific to the respective invitee in response to the respective invitee responding to an invitation, wherein the message is different based on whether the invitee chooses to attend or not attend the event.

17. The computer program of claim 13, the process further comprising:
providing information to an invitee pertaining to points of interest located within a predetermined proximity to a location of the event.

18. The computer program of claim 13, the process further comprising:
transmitting an electronic invitation to the invitees including custom queries associated with the electronic invitation, wherein the custom queries are generated by the creator of the electronic event.
